(19) United States
(12) Patent Application Publication
(10) Pub. No.: US 2002/0126386 A1
(43) Pub. Date: Sep. 12, 2002

(54) Wavelength locker for tunable lasers, detectors, and filters

(76) Inventors: Charles Jordan, Redwood City, CA (US); C. David Nabors, Sunnyvale, CA (US)

Correspondence Address: WILSON SONSINI GOODRICH & ROSATI, 650 PAGE MILL ROAD, PALO ALTO, CA, 943041050

(21) Appl. No.: 09/800,964

(22) Filed: Mar. 6, 2001

(51) Int. Cl. G02B 5/28; H01S 3/13

(52) U.S. Cl. 359/577; 372/32

(57) ABSTRACT

A wavelength locker for use with tunable optical devices, such as tunable lasers, detectors, or wavelength selection filters is described. The invention enables the determination of an optical wavelength or waveband position of a tunable device. Embodiments of the invention supply a reference wavelength which may be used to tune the tunable device to a specified wavelength or waveband. The invention enables the tunable device to be locked to a desired wavelength. The invention enables discrete and continuously tunable optical wavelength determination and locking across a waveband. Applications for the invention include utilization in optical networks. For instance, the invention may be utilized to reference, tune, and lock an incoming signal at the receiving end of an optical network link. In particular, the invention may be used in tunable laser sources, tunable detectors, or tunable optical signal filters as used in optical fiber communications and DWDM applications.

### BACKGROUND OF THE INVENTION

1. Field of the Invention

This invention relates to the field of optical devices. In particular, the invention relates to tunable optical semiconductor devices, such as tunable semiconductor lasers, detectors, and filters.

2. Description of the Related Art

Tunable optical devices, such as tunable lasers, detectors, and filters, have been proposed for diverse applications, such as the fields of telecommunications, medical devices, and optical computing. For instance, tunable lasers have been proposed for use in optical communications, and specifically for Dense Wave Division Multiplexing (WDM). Tunable optical detectors and filters also share a wide range of possible applications.

While tuning a tunable optical device to a specific wavelength, there is a need to provide a wavelength positioning reference to the tunable device. There is also a need to supply a set of locking references at one or more specified wavelengths, or across a wavelength range. Such reference and locking signals are needed to verify a position of the tunable optical device, and to lock the tunable device to any specified wavelength. Though wavelength lockers have been proposed, in patents such as U.S. Pat. No. 5,798,859, entitled “Method and Device for Wavelength Locking,” such systems do not address such problems, as they have not been designed for use with a tunable device.

### SUMMARY OF THE INVENTION

The invention comprises a wavelength locker for use with tunable optical devices, such as tunable lasers, detectors, or wavelength selection filters. The invention enables the determination of an optical wavelength or waveband position of a tunable device. Embodiments of the invention supply a reference wavelength which may be used to tune the tunable device to a specified wavelength or waveband. The invention also enables the tunable device to be locked to a desired wavelength. Embodiments enable discrete and continuously tunable optical wavelength determination and locking across a waveband.

Representative applications for the invention include, but are not limited to, utilization in optical networks. For instance, the invention may be employed to reference, tune, and lock an incoming signal at the receiving end of an optical network link. In particular, the invention may be used in tunable laser sources, tunable detectors, or tunable optical signal filters as used in optical fiber communications and DWDM applications. Embodiments of the invention include a locking member, which may be a Fabry-Perot etalon. The etalon may be solid or air spaced. The locking member inserts a series of transmission peaks to the optical signal. These transmission peaks may be spaced at uniform intervals. In embodiments of the invention, the uniform interval may be one of 200 GHz, 100 GHz, 50 GHz. In some embodiments, the Fabry-Perot etalon is a multi-cavity etalon. In other embodiments, the Fabry-Perot etalon is a multi-step etalon. In embodiments, the transmission peaks inserted by the locking member comprise a tapered envelope of transmission peaks. In embodiments, the Fabry-Perot etalon includes a tuning plate inside a cavity of the Fabry-Perot etalon.

The wavelength locker also includes a wavelength reference member. In embodiments, this may be a passband device. In some such embodiments, the passband device is used in transmission mode. In other embodiments, the passband device is used in reflection mode. These and other embodiments are more fully described infra.

### BRIEF DESCRIPTION OF THE FIGURES

FIG. 1 illustrates several configurations of a wavelength locker.

FIG. 2a-2c illustrate locking and referencing signals.

FIG. 3 illustrates a tapered envelope signal used for referencing and locking in embodiments of the invention.

FIG. 4 illustrates alternative embodiments of the wavelength locker.

### DETAILED DESCRIPTION

A. System Overview

The invention enables the determination of an optical wavelength or waveband position of a tunable device, which may include but is not limited to a tunable laser, tunable detector, or tunable wavelength selection filter. The invention supplies a reference wavelength which may be used to tune the tunable device to a specified wavelength or waveband. Upon tuning the device to the desired wavelength, the invention enables the tunable device to be locked to the wavelength.

Applications for the invention include utilization in optical networks. For instance, the invention may be utilized to reference, tune, and lock an incoming signal at the receiving end of an optical network link. In particular, the invention may be used in tunable laser sources, tunable detectors, or tunable optical signal filters as used in optical fiber communications and DWDM applications. The invention may be utilized in an ITU grid in fiber optic communication applications; to verify tunable lasers; to verify a filter's position on the wavelength grid; or to lock the tunable device to any specified wavelength or frequency. The invention enables discrete and continuously tunable optical wavelength determination and locking across a waveband. Other applications of the invention will be apparent to those skilled in the art.

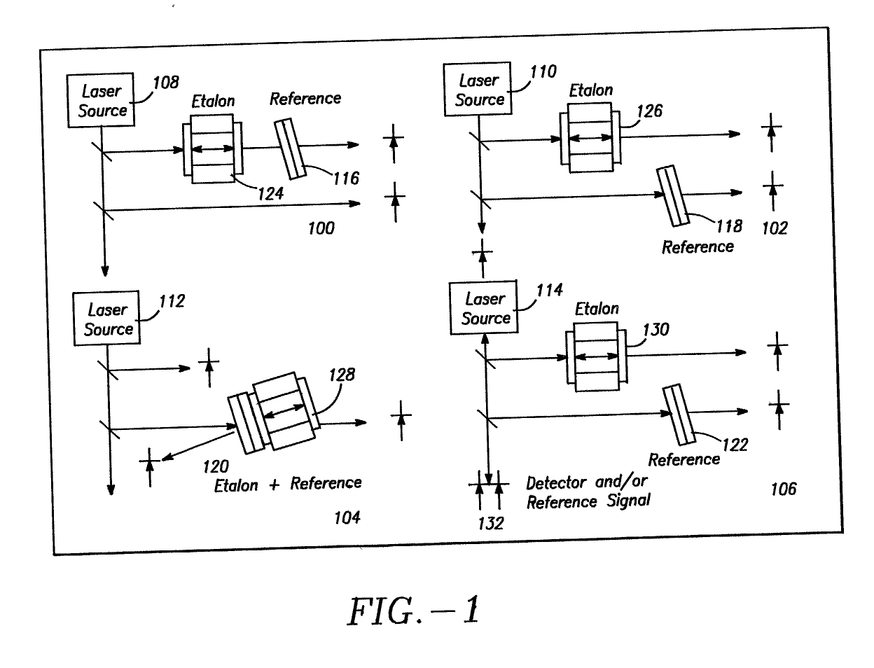

FIG. 1 illustrates several possible configurations of the invention 100 102 104 106. In each of the configurations 100 102 104 106, a laser source 108 110 112 114 feeds a signal into a reference device 116 118 120 122; this reference device may be a transmission filter in embodiments of the invention. The configurations 100 102 104 106 also include a locking component 124 126 128 130, which may be a Fabry-Perot etalon. This etalon may be solid or air spaced. One such configuration 106 may include a reference signal device 132.

In embodiments of the invention, transmission peaks are placed at specified positions on a waveband; this waveband may be leaving the tunable laser source 108 110 112 114, or entering a tunable receiver, which may comprise a tunable detector or a tunable wavelength selection filter. By providing the transmission peaks at the specified positions, a locking signal may be identified by the tunable device. The invention may also employ any one of several techniques to provide a wavelength or waveband reference to a photodetector. These may include, but are not limited to, a tightly controlled transmission or reflection signal, or an electronically curve-fitable change in the transmitted or reflected signal. Other methods of providing a wavelength reference will be apparent to those skilled in the art.

The invention employs the wavelength reference to supply a reference signal to the photodetector during the tuning of the device; this signal is supplied at a particular waveband position of the tunable device. The reference signal is used to establish one or more known wavelengths, in relation to relevant tuning parameters of the tuning device; these tuning parameters may include, but are not limited to one or more of the following: tuning voltage, temperature, current stress. Other relevant parameters are discussed in U.S. Pat. No. 6,181,717, entitled “Tunable Semiconductor Laser System,” inventors Peter Kner, Gabriel Li, Phillip Worland, Rang-Chen Yu, and Wupen Yuen, which is hereby incorporated by reference in its entirety. This reference signal allows the tunable device to lock the signal to a specified wavelength or waveband by use of electronic signal processing and electronic feedback to the tunable device which employs the detector signals.

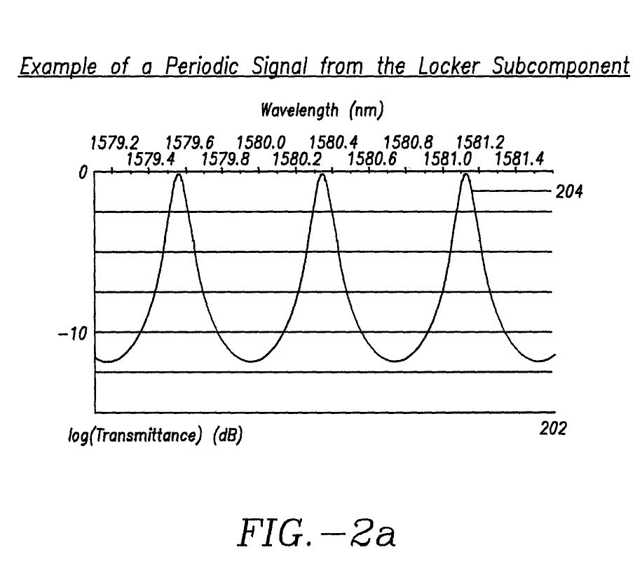

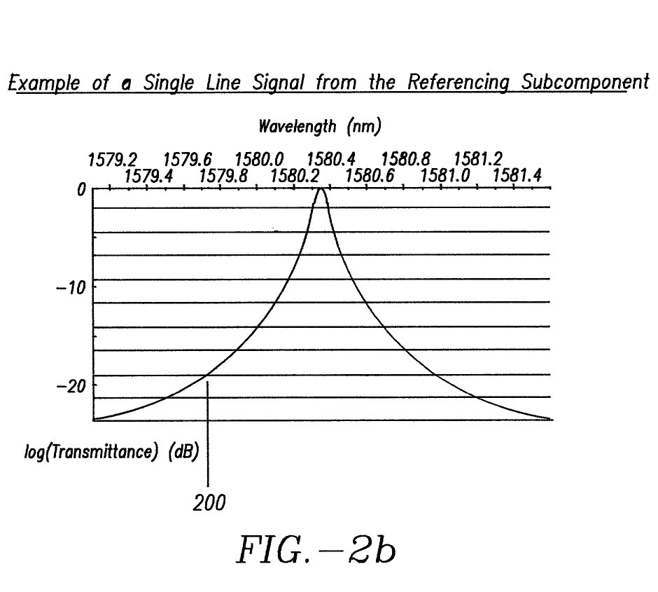

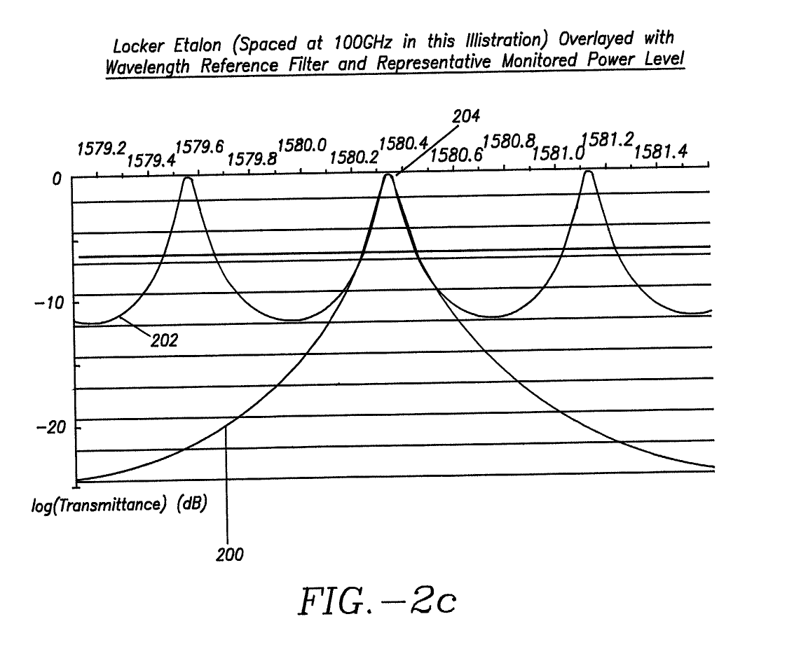

FIG. 2a-2c illustrate the use of a reference signal 200 to identify a wavelength position 204 of a signal 202. In the non-limiting embodiment illustrated in FIG. 2c, a locker etalon spaced at 100 GHz is overlayed with a wavelength reference 200 from a wavelength reference filter to identify a wavelength position 204 of the signal 202.

In an embodiment of the invention, the wavelength or waveband position reference signal comes from a narrow bandpass filter centered at a specified wavelength. In such embodiments, as the tunable device tunes across the waveband, the filter identifies the signal when it tunes to the specified wavelength and transmits (or alternatively, reflects) the light to the photodetector.

Other embodiments employ different methods for providing a wavelength discrimination signal. Some such embodiments provide a unique signature of signals that may be used to identify wavelengths to the tunable device. The reference signal may be used to determine the wavelength position of the tunable device during the turn-on, initialization, re-initialization, or operation of the device; this reference signal may be used to determine the accuracy of the wavelength reference.

In embodiments of the invention, the locking signal provided by the etalon provides a signal or set of signals spaced at a specified set of wavelengths, with an accurately specified finesse and free spectral range; the signal may have a set of transmission peaks spaced at uniform wavelength (alternatively, frequency) intervals. As a non-limiting example, the peaks may be spaced at intervals of 200 Ghz, 100 Ghz, 50 Ghz, or any other spacing specified by the ITU optical network wavelength grid. As the tunable device is tuned by use of the fixed reference filter, the transmission signals from the locker component may be used to continuously maintain knowledge of the wavelength position. In particular, the transmission signals of known wavelength spacing may be counted, and related back to the tuning parameters of the tunable device. As such, the locking component of the invention is used to determine wavelength position across the waveband during the operation of the device; the device's wavelength is locked to the desired position within the waveband by way of electronic feedback to the device.

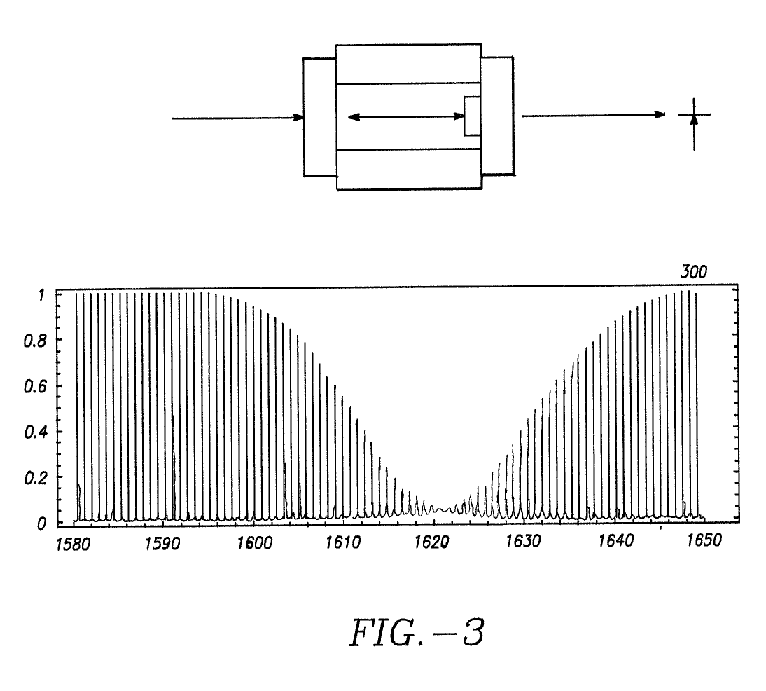

In one such embodiment, a tapered envelope of transmission (or alternatively reflection) peaks provides a set of narrowband signals for locking; the tapered transmission profile may be electronically fitted to determine a wavelength position. Such a tapered envelope 300 is illustrated in FIG. 3. In embodiments of the invention, the tapered envelope may be supplied by a multi-cavity Fabry-Perot etalon.

The source of the signal of the device—which may comprise any one of a transmitted laser, received detector signal, or filter signal—can be coupled into the reference and locker system by a number of techniques. These coupling techniques may include fiber coupling, or beam splitters, which may come directly from the source of the signal. The beam splitting and steering devices are illustrated in FIG. 1. Other techniques for coupling the signal into the reference and locker system will be apparent to those skilled in the art.

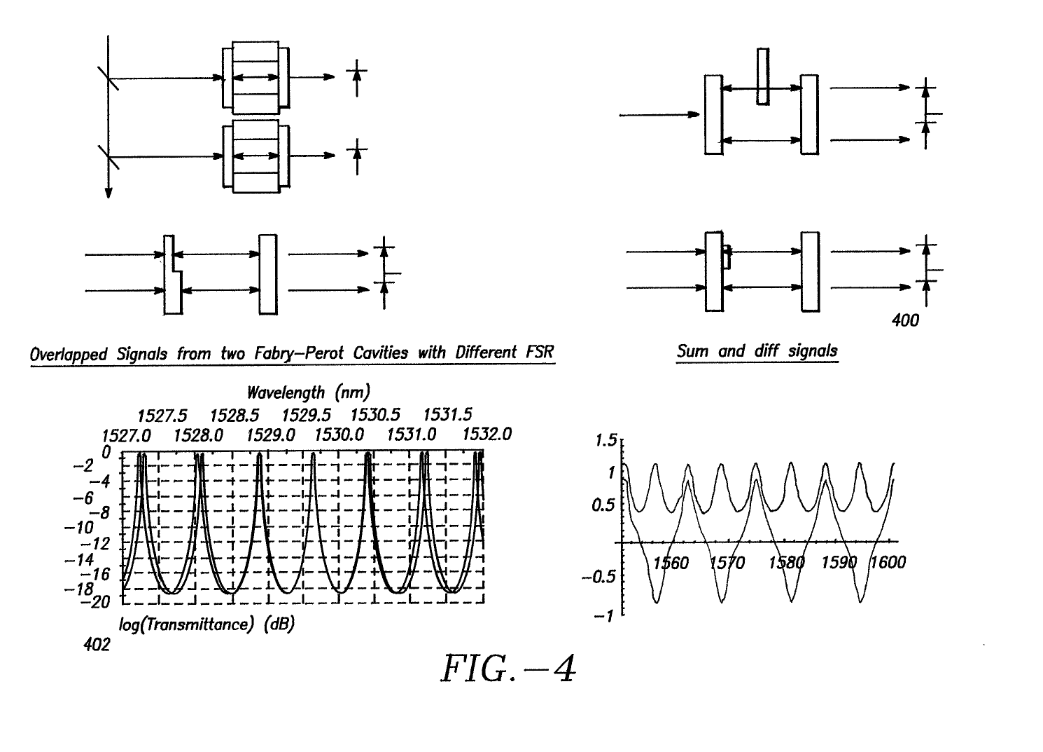

FIG. 4 illustrates alternative configurations of the invention 400. In embodiments of the invention, a multi-step Fabry-Perot etalon may be used to provide a set of reference transmission signals and a set of offset transmission signals that may be discriminated to determine the wavelength position of the signal. An arrangement of two Fabry-Perot etalons with offset Free Spectral Ranges may provide (1) wavelength locking from one etalon on the specified wavelength grid and (2) position referencing by way a single point overlap transmission signals or specified or interpolated spacing determination 402. A vernier tuning plate inside a Fabry-Perot cavity may be used to provide a discrimination signal for referencing and locking.

The foregoing description of various embodiments of the invention has been presented for purposes of illustration and description. It is not intended to limit the invention to the precise forms disclosed. Many modifications and equivalent arrangements will be apparent.

What is claimed is:

1. In a tunable optical device, a method of locking an optical signal emitted by the tunable device to one or more wavelengths, the method comprising:
providing a periodic locking signal for locking the tunable device, wherein the periodic locking signal is derived from a Fabry-Perot etalon coupled to the tunable device;
providing a wavelength reference to the tunable device;
while tuning the device, determining a wavelength position of the device by use of the wavelength reference and the periodic locking signal.

2. The method of claim 1, further including the tunable device locking to the one or more wavelengths.

3. The method of claim 2, wherein the one or more wavelengths comprise at least two wavelengths.

4. The method of claim 3, wherein the one or more wavelengths comprise four or more wavelengths.

5. The method of claim 1, wherein the Fabry-Perot etalon is air-spaced.

6. The method of claim 1, wherein the Fabry-Perot etalon is solid.

7. The method of claim 1, wherein providing the waveband reference is performed by a passband device.

8. The method of claim 7, wherein the passband device is used in transmission mode.

9. The method of claim 8, wherein the passband device is used in reflection mode.

10. The method of claim 1, wherein the Fabry-Perot etalon is a multi-cavity etalon.

11. The method of claim 10, wherein the multi-cavity Fabry-Perot etalon provides a tapered envelope of transmission peaks.

12. The method of claim 10, wherein the multi-cavity Fabry-Perot etalon provides a tapered envelope of reflection peaks.

13. The method of claim 1, wherein the Fabry-Perot etalon is a multiple step etalon.

14. The method of claim 13, wherein providing the locking signal further includes providing a set of reference transmission signals and a set of offset transmission signals.

15. The method of claim 1, wherein the Fabry-Perot etalon includes a tuning plate inside a cavity of the Fabry-Perot etalon.

16. The method of claim 15, further including:
providing a discrimination signal for referencing and locking by use of the tuning plate.

17. The method of claim 1, wherein the tunable device is one of a tunable laser, tunable filter and tunable detector.

18. A wavelength tunable locker coupled to a tunable optical device, the wavelength tunable locker comprising:
an etalon optically coupled to the tunable optical device, wherein the etalon receives a first portion of an optical signal from the optical device, such that the etalon inserts one or more transmission peaks on the first portion of the optical signal;
a wavelength reference member optically coupled to the tunable optical device, wherein the wavelength reference member receives a second portion of the optical signal from the tunable optical device, such that the wavelength reference member provides a reference wavelength for the optical signal;
a control loop coupling the tunable locker to the optical device, wherein the control loop adjusts one or more operating parameters of the tunable device in response to a comparison of the reference wavelength and at least one of the one or more transmission peaks inserted by the etalon.

19. The wavelength tunable locker of claim 18, wherein the one or more transmission peaks include at least two transmission peaks.

20. The wavelength tunable locker of claim 18, wherein the one or more transmission peaks include four or more transmission peaks.

21. The wavelength tunable locker of claim 20, wherein the one or more transmission peaks are evenly spaced at uniform intervals.

22. The wavelength tunable locker of claim 21, wherein the uniform intervals are spaced at 200 GHz.

23. The wavelength tunable locker of claim 21, wherein the uniform intervals are spaced at 100 GHz.

24. The wavelength tunable locker of claim 23, wherein the uniform intervals are spaced at 50 GHz.

25. The wavelength tunable locker of claim 18, wherein the etalon is a Fabry-Perot etalon.

26. The wavelength tunable locker of claim 25, wherein the Fabry-Perot etalon is air-spaced.

27. The wavelength tunable locker of claim 25, wherein the Fabry-Perot etalon is solid.

28. The wavelength tunable locker of claim IS, wherein the wavelength reference member is a passband device.

29. The wavelength tunable locker of claim 28, wherein the passband device is used in transmission mode.

30. The wavelength tunable locker of claim 28, wherein the passband device is used in reflection mode.

31. The wavelength tunable locker of claim 25, wherein the Fabry-Perot etalon is a multi-cavity etalon.

32. The wavelength tunable locker of claim 31, wherein the one or more transmission peaks comprise a tapered envelope of transmission peaks.

33. The wavelength tunable locker of claim 31, wherein the one or more transmission peaks comprise a tapered envelope of reflection peaks.

34. The wavelength tunable locker of claim 25, wherein the Fabry-Perot etalon is a multiple step etalon.

35. The wavelength tunable locker of claim 25, wherein the Fabry-Perot etalon includes a tuning plate inside a cavity of the Fabry-Perot etalon.

36. The wavelength tunable locker of claim 18, wherein the tunable device is one of a tunable laser, a tunable detector, a tunable filter.

37. A wavelength locker for a tunable wavelength device, the wavelength locker comprising:
means for inserting transmission peaks in an optical signal received from the tunable device;
means for providing a wavelength reference of the optical signal to a photodetector in the wavelength locker;
means for comparing the wavelength reference to at least one of the transmission peaks;
means for tuning the tunable wavelength device in response to the comparing the current wavelength to the at least one of the transmission peaks.
